(19) United States
(12) Patent Application Publication
(10) Pub. No.: US 2009/0293717 A1
(43) Pub. Date: Dec. 3, 2009

(54) METHOD AND APPARATUS FOR PRODUCING AND STORING OZONE USING ADSORBENT

(76) Inventors: Jun IZUMI, Isahaya-shi (JP); Hong X. WANG, Nagasaki-shi (JP)

Correspondence Address: FITCH EVEN TABIN & FLANNERY, 120 SOUTH LASALLE STREET, SUITE 1600, CHICAGO, IL, 60603-3406, US

(21) Appl. No.: 12/475,135

(22) Filed: May 29, 2009

(30) Foreign Application Priority Data
Jun. 2, 2008 (JP) 2008-144154

(51) Int. Cl. B01D 53/04; B01D 53/047; B01D 53/30

(52) U.S. Cl. 95/22; 95/95; 95/105; 95/100; 95/99; 96/144

(57) ABSTRACT

The present invention provides a low-cost ozone production method and apparatus for carrying out ozone/oxygen separation using an ozone adsorbent, that re-uses the recovered oxygen as a feed for ozone production, and that desorbs and recovers the adsorbed ozone using dry air. In the method and apparatus, a gas containing an ozone and oxygen two-component gas supplied from an ozone generator is pressurized, introduced into an ozone adsorbent-packed adsorption column, and brought into contact with the adsorbent to adsorb the ozone to the adsorbent. Using dry air as a counterflow purge gas for the adsorbed ozone, the ozone is desorbed from the ozone adsorbent-packed adsorption column loaded with adsorbed ozone by depressurizing the adsorption column or air is introduced as a purge gas from the rear of the column into the adsorbent bed, whereby an ozone and air two-component gas is recovered. The method and apparatus use, as the ozone adsorbent, at least one selected from the group consisting of (1) pentasil-type zeolites, (2) acid-treated pentasil-type zeolites, (3) mesoporous silica, and (4) acid-treated mesoporous silica.

### RELATED APPLICATIONS

This application claims priority under 35 U.S.C. §119 to Japanese Patent Application No. JP2008-144154 filed on Jun. 2, 2008, the entire content of which is hereby incorporated by reference.

### BACKGROUND OF THE INVENTION

1. Field of the Invention

The present invention relates to a method and apparatus for producing and storing ozone that utilizes the difference between the amount of ozone adsorbed by an ozone adsorbent at a higher adsorption pressure and the amount adsorbed at a lower desorption pressure. More particularly, the present invention relates to a method of producing ozone by ozone adsorption and desorption according to pressure-swing adsorption (PSA) using a specific adsorbent that exhibits a high ozone adsorption capacity.

2. Description of the Related Art

Ozone has a very strong oxidizing action and exhibits bleaching-, deodorization-, and sterilizing-properties. For example, with regard to deodorization, it provides a performance that is as much as several hundred times that of activated carbon, and it is thus able to remove substances that to date have been difficult to eliminate. For these reasons, the use of ozone for water purification and for cleansing the atmosphere has been increased.

However, ozone is very expensive as an oxidizing agent due to the need of a silent discharge that uses oxygen as its feed, and this has been one factor hindering the spread use of ozone as an oxidizing agent.

Ozone-containing gas is generally produced using a low-pressure mercury lamp, a silent discharge apparatus, or a water electrolysis apparatus. The low-pressure mercury lamp is a simple device, but it produces gas having a low ozone concentration of about 0.5 mass %, also has a low production rate of about 1 g/h, and has a very large power consumption per unit quantity of ozone and consequently, is not practical for use on an industrial basis. The water electrolysis apparatus does provide a gas containing ozone at a high concentration of about 20 mass %, but has a low production rate of about 1 kg/h and again has a fairly large power consumption per unit quantity of ozone and is unsuitable for use when ozone is required in larger amounts or where the economics are critical. The silent discharge apparatus has the ability to provide large production rates of about 30 kg/h and among the three, also has the lowest power consumption per unit quantity of ozone, but the ozone concentration in the ozone-containing gas produced by a silent discharge apparatus is low at about 3 mass %. Thus, the silent discharge apparatus is the most preferred ozone producing apparatus among these existing technologies, but improvements have been desired with regard to two aspects of the cost of ozone production, i.e., the power consumption and the oxygen producing apparatus.

Japanese Patent Application Laid-open No. S53-64690 discloses oxygen-recycle ozone producing devices as ozone producing devices that improve upon the drawbacks described above for the silent discharge apparatus. Such an oxygen-recycle ozone producing device is intended to economize on power by using oxygen as the ozone production starting material that is fed to the ozone generator and thereby producing twice the amount of ozone at the same power consumption as when air is used as the starting material. This device uses liquid oxygen as its oxygen source and produces ozone by introducing this liquid oxygen to the ozone generator. The resulting ozone-containing gas is cooled to about −60° C. by a heat exchanger or a refrigerator and is thereafter introduced into an ozone adsorption column packed with silica gel, where the ozone is adsorbed.

As noted above, silica gel is known to be an ozone adsorbent; however, it does not have a very large ozone adsorption capacity and large amounts of silica gel are thus required in order to secure the treatment of a prescribed quantity of gas. The adsorption apparatus is therefore also required to be implemented on a large scale.

In the device described above for the prior art, an increase in the ozone adsorption capacity has thus been pursued by using the low temperature of liquid oxygen. This is achieved by using liquid oxygen as the oxygen source and by pre-drying the purge gas and thereafter introducing it into the adsorption column.

However, while the ozone adsorption capacity of silica gel does increase as the temperature declines, it is quite difficult to reach temperatures lower than −60° C., even using special refrigerators. In addition, large amounts of adsorbent must generally be used in order to treat large amounts of gas, and the apparatus must therefore be scaled up and the construction costs and running costs for the apparatus are then increased. In particular, the apparatus as disclosed in Japanese Patent Application Laid-open No. S53-64690 has a very high apparatus production cost and running cost, and as a result, there have been problems with its practical realization.

In order to address the drawbacks of the silica gel-based oxygen-recycle ozone producing device described above, Japanese Patent Application Laid-open No. H11-292514 discloses a method and apparatus for producing a gas containing a high concentration of ozone that use a specific high-silica ozone adsorbent that has an SiO₂/Al₂O₃ molar ratio of at least 20 and that exhibits an excellent ozone adsorption performance even in systems that contain moisture. The proposed method and apparatus can efficiently concentrate ozone using this adsorbent in a PSA device.

By employing a high-silica zeolite having an SiO₂/Al₂O₃ ratio of at least 20, the invention described in Japanese Patent Application Laid-open No. H11-292514 can secure an ozone adsorption capacity that is at least 8 times that of silica gel. However, ozone degradation during adsorption is not completely inhibited, and bringing the adsorption temperature to a low temperature of about −30° C. has been necessary in order to reduce ozone degradation during adsorption. The ozone concentration operation, for example, control of the adsorption column temperature through the use of a low-temperature recycle, is thus quite complex, and equipment and running costs must also be allocated to achieving this low temperature. As a consequence, there has been demand for an efficient ozone concentration operation that can be run at ambient temperature.

### SUMMARY OF THE INVENTION

The present invention seeks to address the drawbacks present in the prior art by elucidating, for the ozone adsorbent, an adsorbent that exhibits an even better adsorption capacity than the heretofore used ozone adsorbents.

As a result of intensive investigations directed to addressing the drawbacks described above, the inventors discovered that an excellent ozone adsorption capacity and a low ozone degradation rate are obtained when a (1) pentasil-type zeolite, (2) acid-treated pentasil-type zeolite, (3) mesoporous silica, and/or (4) acid-treated mesoporous silica is used as the ozone adsorbent. The present inventors then discovered that ozone could be very efficiently produced at a minimum oxygen feed by using this ozone adsorbent as the ozone adsorbent in PSA. The present invention was achieved based on these findings.

The present invention thus provides the following inventions 1 to 13.

1. A method of producing an ozone and air two-component gas, the method comprising:

introducing an ozone and oxygen two-component feed gas produced by an ozone generator, into an adsorption column containing a bed of ozone adsorbent and adsorbing the ozone, at an adsorption pressure, to the adsorbent and recovering an outflowing oxygen-rich gas;

closing, when ozone adsorption is complete, a valve that switches the inflow of the ozone and oxygen two-component feed into the adsorption column, to terminate the feed of this gas into the adsorption column;

finishing the adsorption step by closing a valve that switches the outflow of gas from the adsorption column;

desorbing ozone from the adsorbent bed by opening the feed inflow port used in the adsorption step and thereby reducing the pressure of the adsorbent bed; and

recovering this ozone as an ozone and air two-component gas, wherein as the ozone adsorbent, at least one selected from (1) pentasil-type zeolites, (2) mesoporous silica, (3) acid-treated pentasil-type zeolites, and (4) acid-treated mesoporous silica is used.

2. A method of producing an ozone and air two-component gas, the method comprising:

introducing an ozone and oxygen two-component feed gas produced by an ozone producing apparatus, into an adsorption column containing a bed of ozone adsorbent and adsorbing the ozone, at an adsorption pressure, to the adsorbent and recovering an outflowing oxygen-rich gas; closing, when ozone adsorption is complete, a valve that switches the inflow of the ozone and oxygen two-component feed into the adsorption column, to terminate the feed of this gas into the adsorption column;

finishing the adsorption step by closing a valve that switches the gas outflow from the adsorption column;

desorbing ozone from the adsorbent bed by opening a gas inflow port and an outflow port used in the adsorption step and introducing air from an air drying apparatus through the gas outflow port of the adsorption column such that this air serves as a purge gas and is introduced to maintain a regeneration pressure below the adsorption pressure; and

recovering the desorbed ozone-containing gas as an ozone and air two-component gas, wherein as the ozone adsorbent, at least one selected from (1) pentasil-type zeolites, (2) mesoporous silica, (3) acid-treated pentasil-type zeolites, and (4) acid-treated mesoporous silica is used.

3. A method of producing an ozone and air two-component gas, the method comprising:

introducing an ozone and oxygen two-component feed gas produced by an ozone generator into one adsorption column of two or more adsorbent bed-containing adsorption columns present in parallel and adsorbing the ozone, at an adsorption pressure, to the adsorbent and recovering an outflowing oxygen-rich gas;

carrying out, during an interval in the adsorption step of re-using the recovered oxygen-rich gas as feed for the ozone generator, a desorption step by opening a feed inflow port used in the adsorption step at another adsorption column that has completed the adsorption step to reduce the pressure of the adsorbent bed and thereby desorbing ozone from the adsorbent bed, and recovering the ozone gas as an ozone and air two-component gas;

then switching introduction of the feed gas from the adsorption column that has completed the adsorption step to the adsorption column that has completed the desorption step; and

repeating the process described above, wherein

as the ozone adsorbent, at least one selected from (1) pentasil-type zeolites, (2) acid-treated pentasil-type zeolites, (3) mesoporous silica, and (4) acid-treated mesoporous silica is used.

4. A method of producing an ozone and air two-component gas, the method comprising:

introducing an ozone and oxygen two-component feed gas produced by an ozone generator into one adsorption column of two or more adsorbent bed-containing adsorption columns present in parallel and adsorbing the ozone, at an adsorption pressure, to the adsorbent and recovering outflowing oxygen-rich gas;

carrying out, during an interval in the adsorption step of re-using the recovered oxygen-rich gas as feed for the ozone producing apparatus, a desorption step by opening, at another adsorption column that has completed the adsorption step, a feed inflow port used in the adsorption step and an oxygen-rich gas outflow port for the adsorption step and introducing air from an air drying apparatus through the gas outflow port of the adsorption column and thereby desorbing ozone from the adsorbent bed and recovering the ozone gas as an ozone and air two-component gas such that this air serves as a purge gas and is introduced to maintain the regeneration pressure below the adsorption pressure;

then switching the introduction of feed gas from the adsorption column that has completed the adsorption step to the adsorption column that has completed the desorption step; and

repeating the process described above, wherein

as the ozone adsorbent, at least one selected from (1) pentasil-type zeolites, (2) acid-treated pentasil-type zeolites, (3) mesoporous silica, and (4) acid-treated mesoporous silica is used.

5. The method of producing an ozone and air two-component gas according to 2 or 4 above, wherein the air used as the purge gas is dry air and preferably is dry air that has a dew point of 213 K or below.

6. The method of producing an ozone and air two-component gas according to 2 or 4 above, wherein the flow rate of the air used as the purge gas is determined by the following formula (1)

Gp=k·G₀·Pd/Pa (1)

(where, Gp represents the amount (m³N/h) of dry air used as purge gas; k is in the range from 1 to 2; G₀ represents the amount (m³N/h) of inlet gas; Pd represents the regeneration pressure (kPa); and Pa represents the adsorption pressure (kPa)).

7. The method of producing an ozone and air two-component gas according to any one of 1 to 4 above, wherein the pentasil-type zeolite is silicalite that has an SiO₂/Al₂O₃ molar ratio of at least 20.

8. The method of producing an ozone and air two-component gas according to any one of 1 to 4 above, wherein the pentasil-type zeolite is acid-treated silicalite that has an SiO₂/Al₂O₃ molar ratio of at least 20.

9. The method of producing an ozone and air two-component gas according to any one of 1 to 4 above, wherein the mesoporous silica has an SiO₂/Al₂O₃ molar ratio of at least 20.

10. The method of producing an ozone and air two-component gas according to any one of 1 to 4 above, wherein the mesoporous silica is treated with acid and has an SiO₂/Al₂O₃ molar ratio of at least 20.

11. The method of producing an ozone and air two-component gas according to any one of 1 to 4 above, wherein ozone adsorption is carried out in the range from room temperature to −60° C.

12. The method of producing an ozone and air two-component gas according to any one of 1 to 4 above, wherein the ozone-containing gas is produced by a silent discharge ozone producing apparatus.

13. An ozone gas producing apparatus for carrying out the method according to any one of 1 to 4 above, which introduces an ozone and oxygen two-component gas feed produced by an ozone producing apparatus, into a packed column that contains at least one selected from (1) pentasil-type zeolites, (2) mesoporous silica, (3) acid-treated pentasil-type zeolites, and (4) acid-treated mesoporous silica as an ozone adsorbent bed, adsorbs ozone to the adsorbent by passing the ozone and oxygen two-component gas feed through the adsorbent bed and recovers an oxygen-rich gas, terminates the introduction of the ozone-containing gas when ozone adsorption has been completed, and desorbs ozone by reducing a pressure in the adsorbent bed or introduces air as a purge gas into the adsorbent bed from the back of the column, thereby recovering the ozone as an ozone and air two-component gas.

The ozone producing method and apparatus of the present invention use an adsorbent that exhibits an even better ozone adsorption capacity than the heretofore used ozone adsorbents, and as a consequence, can very efficiently produce an ozone and air two-component gas that has a high ozone concentration and can achieve this production at a minimum oxygen feed and with the production of a low rate of ozone degradation on the adsorbent. This makes it possible as a result to produce ozone inexpensively, to downsize the oxygen producing apparatus required for ozone production, and to substantially reduce the production costs and running costs of the ozone producing apparatus. The present invention thus makes it possible to inexpensively supply ozone. With regard, for example, to the use of ozone in an industrial setting, an economical process can be achieved by producing ozone with the method and apparatus of the present invention using electricity at off peak time bands where the rates are cheaper and storing the ozone and then using the stored ozone during the day when rates are higher.

### BRIEF DESCRIPTION OF THE DRAWINGS

FIG. 1 shows an example of an apparatus that is used to carry out the inventive method of producing an ozone and air two-component gas; and

FIG. 2 shows the x-ray diffraction diagram of a pentasil-type zeolite powder used in the present invention.

### DESCRIPTION OF THE PREFERRED EMBODIMENTS

The adsorbent used in the present invention provides a large amount of ozone adsorption per unit mass of the adsorbent and also provides a low degradation rate for the adsorbed ozone. As this adsorbent, the present invention uses at least one adsorbent selected from (1) pentasil-type zeolites, (2) acid-treated pentasil-type zeolites, (3) mesoporous silica, and (4) acid-treated mesoporous silica.

While not intending to limit the present invention to a particular theory, when an aluminosilicate is used as an ozone adsorbent, the ozone is degraded at the strong Lewis acid sites on the solid surface of the aluminosilicate with the production of atomic oxygen. It is thought that the produced atomic oxygen, having a high reactivity, promotes further ozone degradation. In contrast to this, it is believed that the ozone adsorbent used by the present invention, unlike the aluminosilicates heretofore used as ozone adsorbents, does not contain strong Lewis acid sites on the solid surface, which results in little ozone degradation and a high ozone adsorption performance. For aluminosilicates, this is the basis in the ammonia temperature programmed desorption (TPD) test of adsorbents for the appearance of a strong β-peak (high temperature peak) at ammonia reaction sites thought to correspond to strong acid sites.

### (1) Pentasil-Type Zeolites (S-1)

The pentasil-type zeolite encompassed by the ozone adsorbents used in the present invention is known as so-called silicalite. Silicalite denotes a structure obtained by the removal of almost all the aluminum in a zeolite, and silicalite containing up to about 20% noncrystalline material can also be used.

The SiO₂/Al₂O₃ ratio of the pentasil-type zeolite used in the present invention is preferably 20 to 3,000 and more preferably is at least 50. Ozone degradation by catalytically active sites does not appear when the SiO₂/Al₂O₃ ratio is at least 20.

### (2) Acid-Treated Pentasil-Type Zeolites (S-2)

Among the ozone adsorbents used in the present invention, the pentasil-type zeolite raw material is known as so-called silicalite. Treatment of this silicalite by immersion in pH 1 hydrochloric acid solution, filtration, drying for 1 hour at 110° C., then heating to 400° C. at a rate of temperature rise of 50° C./hour and holding for 1 hour at 400° C., yields an acid-treated material that exhibits a strong Bronsted acid site strength. It is thought that, due to the acid treatment, protons form Bronsted acid sites that appear at the surface and ozone degradation is thereby inhibited. In addition, a strongly acidic group OH, is formed at the zeolite surface by the acid treatment, and the ozone molecule then forms, through one of the oxygen atoms at the two ends, a hydrogen bond with the proton of the OH group at the solid surface, resulting in the adsorption of ozone in a molecular form. Acid-treated pentasil-type zeolite containing up to about 20% noncrystalline material is also usable.

The SiO₂/Al₂O₃ ratio of the acid-treated pentasil-type zeolite of the present invention is preferably 20 to 3,000 and more preferably is at least 50. Degradation of the ozone adsorbed to the adsorbent does not occur when the SiO₂/Al₂O₃ ratio is at least 20.

### (3) Mesoporous Silica (S-3)

The SiO₂/Al₂O₃ molar ratio of the mesoporous silica used in the present invention is preferably 20 to 3,000 and more preferably is at least 50. When this ratio is at least 20, the reduction in pore volume due to the presence of high concentrations of aluminosilicate within the mesopores does not occur, nor is there a reduction in ozone adsorption capacity due to a reduction in the quantity of ozone adsorption or a decline in the adsorption rate.

### (4) Acid-Treated Mesoporous Silica (S-4)

The precursor for the acid-treated mesoporous silica used in the present invention has an SiO₂/Al₂O₃ molar ratio preferably of 20 to 3,000 and more preferably of at least 50. Treatment of this precursor by immersion in pH 1 hydrochloric acid solution, filtration, drying for 1 hour at 110° C., then heating to 400° C. at a rate of temperature rise of 50° C./hour and holding for 1 hour at 400° C., yields an acid-treated material that exhibits a strong Bronsted acid site strength. It is thought that, due to the acid treatment, protons form Bronsted acid sites that appear at the surface and ozone degradation is thereby inhibited. In addition, a strongly acidic group OH, is formed at the zeolite surface by the acid treatment, and the ozone molecule then forms, through one of the oxygen atoms at the two ends, a hydrogen bond with the proton of the OH group at the solid surface, resulting in the adsorption of ozone in a molecular form.

The present invention is described herebelow with reference to the drawings.

The ozone generator that produces the ozone and oxygen two-component feed gas used in the present invention may be based on any known method, for example, silent discharge, ultraviolet lamp, water electrolysis, and so forth. In a preferred embodiment, a high-pressure silent discharge apparatus is employed and the oxygen consumption is substantially reduced by returning the oxygen outflowing from the adsorption step of the ozone-concentrating PSA facility to the feed side of this silent discharge apparatus and using this as the oxygen feed.

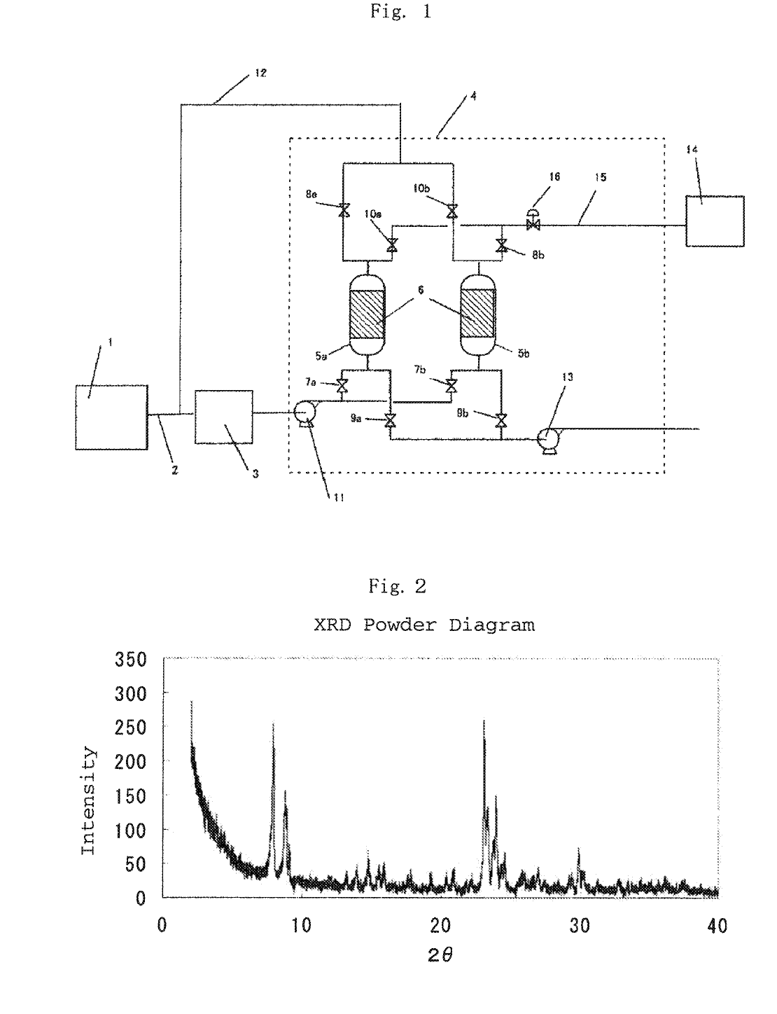

FIG. 1 shows a flow diagram of an apparatus that produces the ozone and air two-component gas from an oxygen feed produced by an oxygen-producing PSA device 1. This oxygen is supplied through a conduit 2 to a silent discharge ozone generator 3, which produces an ozone and oxygen two-component feed gas. This ozone and oxygen two-component feed gas is then supplied to a two-column PSA apparatus 4 that produces the ozone and air two-component gas. However, the feed to the silent discharge ozone generator 3 need not be the oxygen produced by the oxygen-producing PSA device 1, and air can of course be used as the feed to the silent discharge ozone generator 3.

The ozone and oxygen two-component feed gas produced by the silent discharge ozone generator 3 is then pressurized by the blower 11 and fed into either the adsorption column 5a or the adsorption column 5b. An adsorption column 5a or 5b is packed with at least one ozone adsorbent 6 selected from the previously defined ozone adsorbent group.

The ozone and oxygen two-component feed gas is then passed through the ozone adsorbent 6 whereupon the ozone is preferentially adsorbed to the adsorbent 6 due to the adsorption pressure. As a result, the gas exiting the ozone adsorbent 6 is ozone depleted and oxygen-rich. The resulting oxygen-rich gas exits the adsorption column and may be recovered as product or may be circulated via the conduit 12 to the inlet of the ozone generator 3. Circulation of the produced oxygen-rich gas to the inlet of the ozone generator 3 enables the quantity of the oxygen feed to be reduced and enables a reduction in power consumption by the ozone generator 3.

The adsorption step described above is continued until ozone adsorption by the adsorbent 6 no longer occurs. Once the ozone has adsorbed over the whole adsorbent 6 and ozone is no longer adsorbing to the adsorbent 6, the valve that switches the inflow of the ozone and oxygen two-component feed into the adsorption column is closed and the feed of this gas into the adsorption column is terminated. The adsorption step is finished by closing the valve that switches the gas outflow from the adsorption column. At the same time, the valve that switches gas inflow into the other adsorption column, in which the desorption step has been completed, is opened and feed of the ozone and oxygen two-component feed gas into this adsorption column is begun.

There are no particular limitations on the conditions in the adsorption step. The adsorption step is ordinarily run at a pressure from 106 to 507 kPa (1.05 to 5 atm) at a temperature from −60° C. to 25° C.

With regard to finishing the adsorption step, for example, the ozone concentration can be monitored in the gas at the oxygen-rich gas outflow port opposite the inflow port for the ozone and oxygen two-component feed gas, and the completion of adsorption can be taken as the time at which ozone breakthrough has begun to appear. Otherwise, the completion of adsorption can be assigned to the time at which the switching time, i.e., the recycle time, is reached. The adsorption step can be finished by terminating the introduction of the ozone and oxygen two-component feed gas into the adsorption column.

During the interval in which either the adsorption column 5a or 5b is in the adsorption step, the other adsorption column, having already finished the adsorption step, is transferred into the desorption step. Thus, the valve that connects the vacuum pump 13 to the port that is the gas inlet port to the adsorption column during the adsorption step, is opened, which results in the depressurization desorption of a gas having a very high ozone concentration from the adsorption column in the desorption step; this gas flows out of the adsorption column and can be recovered as a high-concentration ozone gas. In the case under consideration, depressurization desorption of the ozone can be allowed to proceed spontaneously—without using the vacuum pump 13—during the interval in which a high desorption pressure prevails, and, after the desorption pressure has reached to around atmospheric pressure and the desorption rate has slowed, use of the vacuum pump 13 can then be initiated.

The desorption step is carried out in the pressure range of 4 to 100 kPa (0.04 to 1 atm). The temperature is not particularly limited and ordinarily depends on the temperature of the adsorption step. When one considers the utilization of the recovered ozone-containing gas, the temperature of the desorption step is preferably around room temperature.

With regard to finishing the desorption step, for example, the completion of desorption can be taken to be the time at which the minimum possible pressure is reached for the desorption pressure or can be assigned to the time at which the switching time, i.e., the recycle time, is reached. The desorption step can be finished by terminating the recovery of the ozone and air two-component gas from the adsorption column.

In addition, as a regeneration step in which the adsorbed ozone is desorbed from the adsorption column after the completion of the adsorption step, air from an air drying apparatus 14, and preferably dry air with a dew point of 213 K or less, is introduced as a purge gas through the gas outflow port of the adsorption column in such a manner that the regeneration pressure is maintained below the adsorption pressure and the ozone is desorbed from the adsorbent 6 and the desorbed ozone-containing gas can be recovered as the ozone and air two-component gas. This can lighten the load on the desorption vacuum pump used in the PSA ozone/oxygen separation facility. The use, for example, of a high-concentration oxygen gas produced by, e.g., an oxygen-concentrating PSA facility, as the oxygen feed gas supplied to the previously cited silent discharge ozone generator is effective for raising the efficiency of the apparatus as a whole and improving the performance of the apparatus as a whole.

The sequence for the preceding is shown in Table 1.

TABLE 1
Sequence for dry air-implemented ozone recovery from a gas containing
O₃ and O₂ components

| | Step | | | |
|---|---|---|---|---|
| Column | 1 | 2 | 3 | 4 |
| Ozone | Adsorption | Adsorption | Counterflow | Pressurization |
| adsorption | | | purge | |
| column A | | | | |
| Ozone | Counterflow | Pressurization | Adsorption | Adsorption |
| adsorption | purge | | | |
| column B | | | | |
| Valve 7a | ◯ | ◯ | | |
| Valve 7b | | | ◯ | ◯ |
| Valve 8a | ◯ | ◯ | | |
| Valve 8b | | | ◯ | ◯ |
| Valve 9a | | | ◯ | |
| Valve 9b | ◯ | | | |
| Valve 10a | | | ◯ | ◯ |
| Valve 10b | ◯ | ◯ | | |
| Vacuum | ◯ | ◯ | ◯ | ◯ |
| pump | | | | |
| Blower | ◯ | ◯ | ◯ | ◯ |

With reference to FIG. 1, the switching valves 7a and 8a are opened and the switching valves 7b and 10b are closed, and the ozone and oxygen two-component feed gas from the ozone generator 3 is pressurized to the adsorption pressure by the blower 11 and is then supplied to the adsorption column 5a which is in the adsorption step. The ozone is thereby adsorbed to the adsorbent 6 and the oxygen gas outflowing from the adsorption column 5a is circulated through the conduit 12 to the inlet for the ozone generator 3. This enables the quantity of the oxygen feed to be reduced and enables a reduction in power consumption by the ozone generator 3. The adsorption step proceeds in the adsorption column 5a.

The adsorption column 5b, having already finished the adsorption step, is transferred into the desorption step. Thus, the switching valves 7b and 10b are closed and the switching valves 9b and 8b are opened and air—preferably dry air—from the air drying apparatus 14 is introduced as a purge gas from the gas outflow port of the adsorption column in such a manner that the regeneration pressure is maintained below the adsorption pressure. The ozone is thereby desorbed from the adsorbent 6 and the desorbed ozone-containing gas is recovered as the ozone and air two-component gas through the switching valve 9b.

The dry air used in the present invention can be obtained using any known method. For example, a moisture absorbent or drying agent, e.g., silica gel, can be filled in the air drying apparatus 14 and air can be passed through the moisture absorbent or drying agent to obtain the dry air. The dry air is preferably brought to a dew point of 213 K or less.

Ozone and air two-component gas is recovered from the desorption step-involved adsorption column of the PSA ozone/oxygen separation facility by, for example, the introduction thereinto of a dry air counterflow as a purge gas at atmospheric pressure or under reduced pressure conditions.

The quantity of purge gas feed is determined as appropriate based on the desired ozone concentration in the ozone and air two-component gas that is produced. Larger quantities of purge gas provide lower ozone concentrations in the ozone and air two-component gas that is produced.

The quantity of purge gas feed can be determined using the following formula (1).

Gp=k·G₀·Pd/Pa (1)

(In the formula, Gp represents the amount (m³N/h) of dry air used as a purge gas; k represents the counterflow purge ratio; G₀ represents the amount (m³N/h) of inlet gas; Pd represents the regeneration pressure (kPa); and Pa represents the adsorption pressure (kPa)).

The purge ratio k can be determined as appropriate based on the desired ozone concentration in the ozone and air two-component gas that is produced. The purge ratio k is preferably in the range of 1 to 2 and more preferably is in the range of 1.2 to 1.5. While the ozone recovery rate does decline when the purge ratio k is 1 or greater, the ozone and air two-component gas obtained at such a purge ratio has a high ozone concentration. When, on the other hand, the purge ratio k is 2 or less, the ozone concentration is lowered but the ozone and air two-component gas is obtained at a high ozone recovery rate.

An oxygen-concentrating PSA device 1 has been disposed upstream from the silent discharge ozone generator 3 in FIG. 1. This oxygen-concentrating PSA device 1 is effective for increasing the efficiency and performance of the apparatus as a whole.

With reference to PSA apparatus 4 for producing the ozone and air two-component gas producing the oxygen that outflows from the adsorption column 5a in the adsorption step is returned through the conduit 12 to the oxygen feed conduit for the silent discharge ozone generator 3, which supports the effective utilization of the oxygen-concentrated gas. The use of a high-pressure silent discharge ozone generator can reduce the load on the compressor used to feed the ozone-containing gas to the PSA facility, and as a consequence is effective for increasing the efficiency and performance of the apparatus as a whole.

Depending on the intended use, a single adsorbent according to the present invention may be used or a mixture of these adsorbents may be used. In addition, the adsorbent of the present invention can be used molded into a freely selected shape, for example, granular, pellet-shaped, Raschig ring-shaped, honeycomb-shaped, and so forth.

### EXAMPLES

The present invention is more specifically described by the examples that follow.

### Production Example 1

### Pentasil-Type Zeolite (S-1)

5.93 g of aluminic acid was dissolved in 440 g of a 22.5 mass % of aqueous tetrapropylammonium hydroxide solution; this was added to 1.00 kg of tetraethyl orthosilicate; and hydrolysis of the tetraethyl orthosilicate was carried out by stirring for approximately 4 hours at 70° C. The obtained powder was placed in an 80° C. dryer and was held there for approximately 3 hours in order to completely finish the hydrolysis. This powder was saturated with water vapor at room temperature to obtain a dry gel containing a 9 to 15 mass % of water fraction, which was packed into a threaded plug-sealable bottle of polypropylene or Teflon (registered trademark). Hydrothermal synthesis was carried out by introduction of this bottle into an electric oven and holding for 72 hours at 140° C.

After the completion of the synthesis, the powder was removed from the sealed bottle and was re-introduced into an electric oven and the temperature was raised in an air atmosphere to 500° C. at a rate of temperature rise of 100° C./hour and the template was removed by holding for 20 hours at this temperature to produce approximately 280 g of silicalite (yield=80%, SiO₂/Al₂O₃=200, BET specific surface area=528 m²/g).

The x-ray diffraction peaks of the obtained crystals are shown in FIG. 2. It can be confirmed from FIG. 2 that the obtained crystals contain MFI crystals. The SiO₂/Al₂O₃ ratio, as measured by elemental analysis (wet analysis) by gravimetry (determination from the weight of the precipitate produced by reaction with a nitron-5% acetic acid aqueous solution and 48% hydrofluoric acid), was 100. The specific surface area measured by the BET method was 528 m²/g. A monolith with a diameter of 10 cm and a height of 10 cm was molded by supporting the obtained adsorbent material on an experimentally fabricated silica monolith substrate so as to provide a bulk specific gravity of 0.4. The same molding method was used for the adsorbent materials described in the following.

Silicalite having an SiO₂/Al₂O₃ molar ratio of 20, 50, 200, 1,000, or 3,000 was obtained using the same synthesis method as described above.

### Production Example 2

### Acid-Treated Pentasil-Type Zeolite (S-2)

Using the silicalite of Production Example 1 as the starting material, acid-treated pentasil-type zeolite exhibiting a strong Bronsted acid site strength was obtained by immersion of the silicalite in pH 1 hydrochloric acid solution, then filtration, drying for 1 hour at 110° C., then heating to 400° C. at a rate of temperature rise of 50° C./hour and holding at 400° C. for 1 hour. Acid-treated pentasil-type zeolite containing up to about 20% noncrystalline material is also usable.

Using the silicalite of Production Example 1 as the starting material, acid-treated silicalite having an SiO₂/Al₂O₃ molar ratio of 20, 50, 200, 1,000, or 3,000 was obtained.

### Production Example 3

### Mesoporous Silica (S-3)

30 to 33 L of an aqueous solution of tetramethylammonium hydroxide (TMAOH, (CH₃)₄N, OH, FW 91.15, from Aldrich (25 weight % in water)) was added to 32 L water in which 6.0 kg cetyltrimethylammonium bromide (CTMAB, C₁₆H₃₅(CH₃)₃NBr, FW 364.45, produced by Tokyo Chemical Industry Co., Ltd.) was dissolved and the pH was adjusted to 7.7.

While vigorously stirring the mixture, 3.00 kg of sodium silicate (Na₂O. 2SiO₂.2.52H₂O, FW 227.56, produced by Kishida Chemical Co., Ltd.) dissolved in 15.4 L of water was added, and the resulting suspension was stirred for 3 hours at room temperature. This suspension had the following gel composition: SiO₂:CTMAB:H₂O=0.8:0.5:190.

The precipitated product was filtered to separate a porous powder. After washing with water, this was placed in an electric oven and the surface moisture fraction was first removed by holding it for approximately 8 hours at 110° C. and the cetyltrimethylammonium bromide was then removed by pyrolysis by raising the temperature to 600° C. at a rate of temperature rise of 100° C./hour and holding the resulting product at 600° C. for 6 hours. Approximately 1 kg (yield=90%) mesoporous silica was prepared.

The powder produced by the above procedure had an SiO₂/Al₂O₃ ratio of 3,000, a specific surface area (measured with a BET surface area measurement instrument from Bel Japan, Inc.) of 767 to 1,100 m²/g, and a pore diameter of 3.5 nm.

X-ray diffraction of the obtained crystals confirmed them to be mesoporous silica. The SiO₂/Al₂O₃ molar ratio in this case was 600.

### Production Example 4

### Heat-Treated Mesoporous Silica (S-4)

Using the mesoporous silica of Production Example 3 as the starting material, silica exhibiting a strong acid site strength was obtained by immersion of the mesoporous silica in pH 1 hydrochloric acid solution, then filtration, drying for 1 hour at 110° C., then heating to 400° C. at a rate of temperature rise of 50° C./hour and holding the resulting product at 400° C. for 1 hour. Acid-treated mesoporous silica containing up to about 20% noncrystalline material is also usable.

Because the mesoporous silica of Production Example 3 was used as the starting material, acid-treated mesoporous silica having an SiO₂/Al₂O₃ molar ratio of 3,000 was obtained.

### Example 1

Using the apparatus for producing the adsorption columns in the ozone/gas shown in FIG. 1, the ozone/oxygen separation performance (air-versus-oxygen replacement performance) of the manufactured adsorbents for ozone/oxygen separation was measured and compared.

The results of the evaluation of the manufactured adsorbents are shown in Table 2 (silica gel was used as the comparative reference).

TABLE 2

| | | | | | | Outlet | Outlet | | |
|---|---|---|---|---|---|---|---|---|---|
| | | | | | | ozone | ozone | | |
| | | | | | | concentration | concentration | | |
| | | | | Outlet flow | Outlet flow | in | in | | Counter- |
| | | | Amount of | rate in the | rate in the | the | the | Ozone | flow |
| | | Amount of | counter flow | desorption | adsorption | adsorption | desorption | recovery | purge |
| Sample | | inlet gas | purge air | step | step | step | step | rate | ratio |
| no. | Sample | (m³N/h) | (m³N/h) | (m³N/h) | (m³N/h) | (vol %) | (vol %) | (%) | (—) |
| 1 | Pentasil-type | 200.00 | 160.00 | 165.70 | 194.30 | 0.15 | 3.21 | 85.50 | 1.20 |
| | zeolite | | | | | | | | |
| | (S-1) | | | | | | | | |
| 2 | Acid-treated | 200.00 | 160.00 | 165.70 | 194.30 | 0.15 | 3.42 | 91.20 | 1.20 |
| | pentasil-type | | | | | | | | |
| | zeolite | | | | | | | | |
| | (S-2) | | | | | | | | |
| 3 | Mesoporous | 140.00 | 112.00 | 115.99 | 136.01 | 0.15 | 3.14 | 83.60 | 1.20 |
| | silica | | | | | | | | |
| | (S-3) | | | | | | | | |
| 4 | Acid-treated | 140.00 | 112.00 | 115.99 | 136.01 | 0.15 | 3.42 | 91.20 | 1.20 |
| | mesoporous | | | | | | | | |
| | silica | | | | | | | | |
| | (S-4) | | | | | | | | |
| 5 | Silica gel | 60.00 | 48.00 | 49.71 | 58.29 | 0.15 | 2.49 | 66.50 | 1.20 |
| | (Reference) | | | | | | | | |

| Adsorption pressure | 120 kPa | | |
|---|---|---|---|
| Regeneration pressure | 80 kPa | | |
| Inlet gas amount | 200 m³N/h | | |
| Cycle time | 5 min | | |
| Adsorption time | 2.5 min/cycle | | |
| Regeneration time | 2.5 min/cycle | | |
| Counter flow purge time | 2.4 min/cycle | | |
| Pressurization time | 0.1 min/cycle | | |
| Column configuration | 0.5 mφ × 2 m, | 0.4 m³/column | 0.8 m³/unit |
| | 2 columns | | |
| Inlet gas composition | Ozone | 3 vol % | |
| | Oxygen | 92.5 vol % | |
| | Ar | 4.5 vol % | |
| Adsorption temperature | 25° C. | | |

For all of the samples, the ozone recovery rate for the ozone recovered from the desorption step was at least 90%, the remaining gas in the recovered ozone was air, the recovery of the throughflowing oxygen from the adsorption step was at least 90%, and the recovered oxygen concentration exceeded 90 vol %, thus demonstrating the efficacy of the present invention. With regard to the ozone/oxygen separation performance, the (1) pentasil-type zeolite (S-1), (2) acid-treated pentasil-type zeolite (S-2), (3) mesoporous silica (S-3) and (4) acid-treated mesoporous silica (S-4) demonstrated a higher separation performance than the silica gel. The acid-treated pentasil-type zeolite exhibited a particularly high ozone recovery. This is believed to be due to a greater inhibition of degradation during ozone adsorption accompanying the increase in the Bronsted acid site strength.

### Example 2

The acid-treated pentasil-type zeolite (S-2), which had the highest adsorbent performance, was then made into a honeycomb and the relationship between the inlet flow rate and the ozone recovery and outlet ozone concentration in the adsorption step was investigated for a cycle time of 5 minutes. The results are shown in Table 3.

TABLE 3

| | | | | Outlet | | | |
|---|---|---|---|---|---|---|---|
| | | | | ozone | | | |
| | | Outlet | | concentration | | | |
| | Flow rate | flow rate | Outlet flow | in | Outlet ozone | | |
| | of counter- | in the | rate in the | the | concentration | | Counter- |
| Flow rate of inlet | flow purge | desorption | adsorption | adsorption | in the desorption | Ozone | flow purge |
| gas | air | step | step | step | step | recovery | ratio |
| (m³N/h) | (m³N/h) | (m³N/h) | (m³N/h) | (vol %) | (vol %) | (%) | (—) |
| 160.00 | 128.00 | 132.70 | 155.30 | 0.06 | 3.31 | 88.20 | 1.20 |
| 200.00 | 160.00 | 165.70 | 194.30 | 0.15 | 3.21 | 85.50 | 1.20 |
| 250.00 | 200.00 | 206.38 | 243.63 | 0.45 | 2.87 | 76.50 | 1.20 |
| 300.00 | 240.00 | 245.40 | 294.60 | 1.20 | 2.03 | 54.00 | 1.20 |

| Adsorbent | Acid-treated pentasil-type zeolite (S-2) | | | | | | |
|---|---|---|---|---|---|---|---|
| Adsorption | 120 | kPa | | | | | |
| pressure | | | | | | | |
| Regeneration | 80 | kPa | | | | | |
| pressure | | | | | | | |
| Cycle time | 5 | min | Adsorption | 2.5 | min/cycle | Pressurization | 0.1 min/cycle |
| | | | time | | | time | |
| Cycle time | 5 | min | Regeneration | 2.5 | min/cycle | Counter- | 2.4 min/cycle |
| | | | time | | | flow purge | |
| | | | | | | time | |

| | | | | | |
|---|---|---|---|---|---|
| Column configuration | 0.5 mφ × | 0.4 | m³/column | 0.8 | m³/unit |
| | 2 m, 2 | | | | |
| | columns | | | | |

| | |
|---|---|
| Inlet gas | ozone 3 vol % |
| composition | |

| | | |
|---|---|---|
| oxygen | 92.5 | vol % |
| Ar | 4.5 | vol % |

| | | |
|---|---|---|
| Adsorption | 25° | C. |
| temperature | | |

As the feed flow rate increases, the ozone recovery decreases and the outlet ozone concentration in the adsorption step increased. According to this experiment, at 200 m³N/h, the outlet ozone concentration in the adsorption step was scrubbed down to 0.15 vol % and the throughflowing oxygen was re-utilized as feed for the ozone generator. With regard, on the other hand, to the adsorbed ozone, when the ozone was desorbed using dry air as the purge gas, the ozone could be recovered as an ozone and air two-component gas at a recovery rate of about 85%.

### Example 3

The acid-treated pentasil-type zeolite (S-2), which had the highest adsorbent performance, was then made into a honeycomb and the relationship between the cycle time and the ozone recovery and outlet ozone concentration in the adsorption step was investigated. The results are shown in Table 4.

TABLE 4

| | | | | | | | | |
|---|---|---|---|---|---|---|---|---|
| | | | | | | Outlet | | |
| | | | | | Outlet | ozone | | |
| | | | | | ozone | concentration | | |
| | | | | | concentration | in | | Counter- |
| | Flow rate | Flow rate of | Outlet flow rate | Outlet flow | in | the | Ozone | flow |
| | amount of | counter flow | in the desorption | rate in the | the adsorption | desorption | recovery | purge |
| Cycle time | inlet gas | purge air | step | adsorption step | step | step | rate | ratio |
| (min) | (m³N/h) | (m³N/h) | (m³N/h) | (m³N/h) | (vol %) | (vol %) | (%) | (—) |

| | | | | | | | | |
|---|---|---|---|---|---|---|---|---|
| 2.50 | 373.21 | 298.57 | 309.10 | 362.69 | 0.18 | 3.17 | 84.60 | 1.20 |
| 5.00 | 200.00 | 160.00 | 165.70 | 194.30 | 0.15 | 3.21 | 85.50 | 1.20 |
| 7.50 | 133.33 | 106.67 | 110.47 | 129.53 | 0.15 | 3.21 | 85.50 | 1.20 |
| 10.00 | 100.00 | 80.00 | 82.85 | 97.15 | 0.15 | 3.21 | 85.50 | 1.20 |

| Adsorbent | Acid-treated pentasil-type zeolite (S-2) | | | |
|---|---|---|---|---|
| Adsorption | 120 | kPa | | |
| pressure | | | | |
| Regeneration | 80 | kPa | | |
| pressure | | | | |
| Column | 0.5 mφ × 2 m, | 0.4 | m³/column | 0.8 m³/unit |
| configuration | 2 columns | | | |
| Inlet gas | Ozone | 3 | vol % | |
| composition | | | | |
| | Oxygen | 92.5 | vol % | |
| | Ar | 4.5 | vol % | |

| | | |
|---|---|---|
| Adsorption | 25° | C. |
| temperature | | |

The flow rate of inlet gas could be increased as the cycle time was shorter while maintaining the outlet ozone concentration in the adsorption step at about 0.15 vol %, and the flow rate of inlet gas could be increased to 373 m³N/h when the cycle time was shortened to 2.5 minutes. It was thus confirmed that the amount of adsorbent used could be reduced by shortening the cycle time.

### Example 4

The acid-treated pentasil-type zeolite (S-2), which had the highest adsorbent performance, was then made into a honeycomb and the relationship between the adsorption pressure and the ozone recovery and outlet ozone concentration in the adsorption step was investigated. The results are shown in Table 5.

TABLE 5

| | | | | | Outlet | Outlet | | |
|---|---|---|---|---|---|---|---|---|
| | | | | | ozone | ozone | | |
| | | | | | concentration | concentration | | Counter- |
| | | Flow rate of | Outlet flow rate in | Outlet flow | in | in | Ozone | flow |
| Adsorption | Flow rate | counter flow | the desorption | rate in the | the adsorption | the desorption | recovery | purge |
| pressure | of inlet gas | purge air | step | adsorption step | step | step | rate | ratio |
| (kPa) | (m³N/h) | (m³N/h) | (m³N/h) | (m³N/h) | (vol %) | (vol %) | (%) | (—) |
| 105.00 | 200.00 | 182.86 | 188.56 | 194.30 | 0.15 | 2.81 | 85.50 | 1.20 |
| 110.00 | 200.00 | 174.55 | 180.25 | 194.30 | 0.15 | 2.94 | 85.50 | 1.20 |
| 115.00 | 200.00 | 166.96 | 172.66 | 194.30 | 0.15 | 3.07 | 85.50 | 1.20 |
| 120.00 | 200.00 | 160.00 | 165.70 | 194.30 | 0.15 | 3.21 | 85.50 | 1.20 |

| Adsorbent | Acid-treated pentasil-type zeolite (S-2) | | | | | | |
|---|---|---|---|---|---|---|---|
| Regeneration | 80 | kPa | | | | | |
| pressure | | | | | | | |
| Cycle time | 5 | min | Adsorption time | 2.5 | min/cycle | | |
| | | | Regeneration time | 2.5 | min/cycle | Counter- | 2.4 min/cycle |
| | | | | | | flow purge | |
| | | | | | | time | |
| | | | | | | Pressurization | 0.1 min/cycle |
| | | | | | | time | |

| | | | | | |
|---|---|---|---|---|---|
| Column | 0.5 mφ × | 0.4 | m³/column | 0.8 | m³/unit |
| configuration | 2 m, 2 | | | | |
| | columns | | | | |
| Inlet gas | Ozone | 3 | vol % | | |
| composition | | | | | |
| | Oxygen | 92.5 | vol % | | |
| | Ar | 4.5 | vol % | | |
| Adsorption | 25° C. | | | | |
| temperature | | | | | |

The quantity of purge air could be reduced as the adsorption pressure was increased, and the ozone concentration in the desorbed gas then increased to reach 3.21 vol % at an adsorption pressure of 120 kPa.

### Example 5

The acid-treated pentasil-type zeolite (S-2), which had the highest adsorbent performance, was then made into a honeycomb and the relationship between the regeneration pressure and the ozone recovery and outlet ozone concentration in the adsorption step was investigated. The results are shown in Table 6.

TABLE 6

| | | | | | Outlet | Outlet | | |
|---|---|---|---|---|---|---|---|---|
| | | | | | ozone | ozone | | |
| | | | | | concentration | concentration | | Counter- |
| | | Flow rate of | Outlet flow rate in | Outlet flow | in | in | Ozone | flow |
| Regeneration | Flow rate | counter flow | the desorption | rate in the | the adsorption | the desorption | recovery | purge |
| pressure | of inlet gas | purge air | step | adsorption step | step | step | rate | ratio |
| (kPa) | (m³N/h) | (m³N/h) | (m³N/h) | (m³N/h) | (vol %) | (vol %) | (%) | (—) |
| 95 | 200.00 | 190.00 | 195.70 | 194.30 | 0.15 | 2.70 | 85.50 | 1.20 |
| 80 | 200.00 | 160.00 | 165.70 | 194.30 | 0.15 | 3.21 | 85.50 | 1.20 |
| 40 | 200.00 | 80.00 | 85.70 | 194.30 | 0.15 | 6.41 | 85.50 | 1.20 |
| 4 | 200.00 | 8.00 | 13.70 | 194.30 | 0.15 | 64.13 | 85.50 | 1.20 |

| Adsorbent | Acid-treated pentasil-type zeolite (S-2) | | | | | | |
|---|---|---|---|---|---|---|---|
| Adsorption | 120 | kPa | | | | | |
| pressure | | | | | | | |
| Cycle time | 5 | min | Adsorption time | 2.5 | min/cycle | | |
| | | | Regeneration time | 25 | min/cycle | Counter- | 2.4 min/cycle |
| | | | | | | flow purge | |
| | | | | | | time | |
| | | | | | | Pressurization | 0.1 min/cycle |
| | | | | | | time | |

| | | | | | |
|---|---|---|---|---|---|
| Column | 0.5 mφ × | 0.4 | m³/column | 0.8 | m³/unit |
| configuration | 2 m, 2 | | | | |
| | columns | | | | |
| Inlet gas | Ozone | 3 | vol % | | |
| composition | | | | | |
| | Oxygen | 92.5 | vol % | | |
| | Ar | 4.5 | vol % | | |
| Adsorption | 25° C. | | | | |
| temperature | | | | | |

The ozone concentration in the ozone and air two-component gas increased as the regeneration pressure was reduced, increasing to 64 vol % at 4 kPa. On the other hand, the ozone recovery maintained 85.5% even at a regeneration pressure of 95 kPa, confirming that the adsorbed ozone could be desorbed by dry air without using a high vacuum as long as the counterflow purge ratio was maintained.

### Example 6

The acid-treated pentasil-type zeolite (S-2), which had the highest adsorbent performance, was then made into a honeycomb and the relationship between the counterflow purge ratio and the ozone recovery and outlet ozone concentration in the adsorption step was investigated. The results are shown in Table 7.

TABLE 7

| | | | | Outlet | Outlet | | |
|---|---|---|---|---|---|---|---|
| | | | | ozone | ozone | | |
| | | | | concentration | concentration | | |
| Flow rate of | | | | in the | in the | | Counter- |
| counter flow | Flow rate of | Outlet flow rate in | Outlet flow rate in | adsorption | desorption | Ozone | flow purge |
| purge air | inlet gas | the desorption step | the adsorption step | step | step | recovery rate | ratio |
| (m³N/h) | (m³N/h) | (m³N/h) | (m³N/h) | (vol %) | (vol %) | (%) | (—) |
| 106.67 | 200 | 109.07 | 197.60 | 1.80 | 2.03 | 36.00 | 0.80 |
| 133.33 | 200 | 138.13 | 195.20 | 0.60 | 3.24 | 72.00 | 1.00 |
| 160.00 | 200 | 165.70 | 194.30 | 0.15 | 3.21 | 85.50 | 1.20 |
| 200.00 | 200 | 205.88 | 194.12 | 0.06 | 2.65 | 88.20 | 1.50 |

| Adsorbent | Acid-treated pentasil-type zeolite (S-2) | | | | | | |
|---|---|---|---|---|---|---|---|
| Adsorption | 120 | kPa | | | | | |
| pressure | | | | | | | |
| Regeneration | 80 | kPa | | | | | |
| pressure | | | | | | | |
| Cycle time | 5 | min | Adsorption time | 2.5 | min/cycle | | |
| | | | Regeneration | 2.5 | min/cycle | Counter- | 2.4 min/ |
| | | | time | | | flow purge | cycle |
| | | | | | | time | |
| | | | | | | Pressurization | 0.1 min/ |
| | | | | | | time | cycle |

| | | | | | |
|---|---|---|---|---|---|
| Column | 0.5 mφ × | 0.4 | m³/column | 0.8 | m³/unit |
| configuration | 2 m, | | | | |
| | 2 columns | | | | |
| Inlet gas | Ozone | 3 | vol % | | |
| composition | | | | | |
| | Oxygen | 92.5 | vol % | | |
| | Ar | 4.5 | vol % | | |
| Adsorption | 25° C. | | | | |
| temperature | | | | | |

The ozone recovery decreased accompanying the reduction in the counterflow purge ratio, while the outlet ozone concentration in the adsorption step increased, and it was shown that ozone/oxygen separation by the pressure-swing method was not practical at a counterflow purge ratio of no more than 1.

### Example 7

The acid-treated pentasil-type zeolite (S-2), which had the highest adsorbent performance, was then made into a honeycomb and the relationship between the adsorption temperature and the ozone recovery and outlet ozone concentration in the adsorption step was investigated. The results are shown in Table 8.

TABLE 8

| | | Flow rate | | | Outlet ozone | Outlet ozone | | |
|---|---|---|---|---|---|---|---|---|
| | | of | | | concentration | concentration | | |
| | Flow | counter- | Outlet flow rate | Outlet flow | in the | in the | Ozone | Counter- |
| Adsorption | rate of | flow | in the desorption | rate in the | adsorption | desorption | recovery | flow purge |
| temperature | inlet gas | purge air | step | adsorption step | step | step | rate | ratio |
| (° C.) | (m³N/h) | (m³N/h) | (m³N/h) | (m³N/h) | (vol %) | (vol %) | (%) | (—) |
| 25 | 200 | 160.00 | 165.70 | 194.30 | 0.15 | 3.21 | 85.50 | 1.20 |
| 0 | 280 | 224.00 | 231.98 | 272.02 | 0.15 | 3.38 | 85.50 | 1.20 |
| −30 | 380 | 304.00 | 314.83 | 369.17 | 0.15 | 3.49 | 85.50 | 1.20 |
| −60 | 564 | 451.20 | 467.27 | 547.93 | 0.15 | 3.53 | 85.50 | 1.20 |

| Adsorbent | Acid-treated pentasil-type zeolite (S-2) | | | | | | |
|---|---|---|---|---|---|---|---|
| Adsorption | 120 | kPa | | | | | |
| pressure | | | | | | | |
| Regeneration | 80 | kPa | | | | | |
| pressure | | | | | | | |
| Cycle time | 5 | min | Adsorption time | 2.5 | min/cycle | | |
| | | | Regeneration | 2.5 | min/cycle | Counter- | 2.4 min/cycle |
| | | | time | | | flow purge time | |
| | | | | | | Pressurization | 0.1 min/cycle |
| | | | | | | time | |

| | | | | | |
|---|---|---|---|---|---|
| Column | 0.5 mφ × | 0.4 | m³/column | 0.8 | m³/unit |
| configuration | 2 m, 2 | | | | |
| | columns | | | | |
| Inlet gas | Ozone | 3 | vol % | | |
| composition | | | | | |
| | Oxygen | 92.5 | vol % | | |
| | Ar | 4.5 | vol % | | |

When the inlet gas amount was increased while holding the outlet ozone concentration in the adsorption step to 0.15 vol %, the ozone concentration in the desorption step then increased as the adsorption temperature decreased. It was possible to treat 2.5 times as much inlet gas at −60° C. as at 25° C. In addition, it is shown that ozone degradation is inhibited since the ozone concentration in the desorbed gas increases.

Because a gas containing a high ozone concentration can be utilized, within the industrial sector it can be used in the fields that require a gas containing a high ozone concentration, for example, as a pulp bleaching agent in the papermaking industry. With regard to semiconductor cleaning, ozonated water comprising dissolved ozone gas, when used as a replacement for RCA cleaning, can lower the environmental load from the standpoint of waste water treatment and can remove and clean organics and metals from semiconductor substrate surfaces. By exploiting the powerful oxidizing activity of ozone, such a gas can be used to disinfect tap water and other potable water. It can also be used for disinfection, sterilization, and exhaust gas treatment in the fields such as medicine, nursing, food products, and agriculture (primarily dairy farming). Moreover, because the method and apparatus of the present invention can be easily installed and used for production, they can be conveniently utilized at fish farms, with raw fish storage vessels, and so forth.

What is claimed is:

1. A method of producing an ozone and air two-component gas, the method comprising:
introducing an ozone and oxygen two-component feed gas produced by an ozone producing apparatus, into an adsorption column containing a bed of ozone adsorbent and adsorbing the ozone, at an adsorption pressure, to the adsorbent and recovering an outflowing oxygen-rich gas;
closing, when ozone adsorption is complete, a valve that switches the inflow of the ozone and oxygen two-component feed into the adsorption column, to terminate the feed of this gas into the adsorption column;
finishing the adsorption step by closing a valve that switches the outflow of gas from the adsorption column;
desorbing ozone from the adsorbent bed by opening a feed inflow port used in the adsorption step and thereby reducing the pressure of the adsorbent bed; and
recovering this ozone as an ozone and air two-component gas, wherein
as the ozone adsorbent, at least one selected from (1) pentasil-type zeolites, (2) mesoporous silica, (3) acid-treated pentasil-type zeolites, and (4) acid-treated mesoporous silica is used.

2. A method of producing an ozone and air two-component gas, the method comprising:
introducing an ozone and oxygen two-component feed gas produced by an ozone producing apparatus, into an adsorption column containing a bed of ozone adsorbent and adsorbing the ozone, at an adsorption pressure, to the adsorbent and recovering an outflowing oxygen-rich gas;
closing, when ozone adsorption is complete, a valve that switches the inflow of the ozone and oxygen two-component feed into the adsorption column, to terminate the feed of this gas into the adsorption column;
finishing the adsorption step by closing a valve that switches the gas outflow from the adsorption column;
desorbing ozone from the adsorbent bed by opening a gas inflow port and an outflow port used in the adsorption step and introducing air from an air drying apparatus through the gas outflow port of the adsorption column, such that this air serves as a purge gas and is introduced to maintain a regeneration pressure below the adsorption pressure; and
recovering the desorbed ozone-containing gas as an ozone and air two-component gas recovered, wherein
as the ozone adsorbent, at least one selected from (1) pentasil-type zeolites, (2) mesoporous silica, (3) acid-treated pentasil-type zeolites, and (4) acid-treated mesoporous silica is used.

3. A method of producing an ozone and air two-component gas, the method comprising:
introducing an ozone and oxygen two-component feed gas produced by an ozone producing apparatus into one adsorption column of two or more adsorbent bed-containing adsorption columns present in parallel and adsorbing the ozone, at an adsorption pressure, to the adsorbent and recovering an outflowing oxygen-rich gas;
carrying out, during an interval in the adsorption step of re-using the recovered oxygen-rich gas as feed for the ozone producing apparatus, a desorption step by opening a feed inflow port used in the adsorption step at another adsorption column that has completed the adsorption step to reduce the pressure of the adsorbent bed, and thereby desorbing ozone from the adsorbent bed, and recovering the ozone gas as an ozone and air two-component gas;
then switching introduction of the feed gas from the adsorption column that has completed the adsorption step to the adsorption column that has completed the desorption step; and
repeating the process described above, wherein
as the ozone adsorbent, at least one selected from (1) pentasil-type zeolites, (2) acid-treated pentasil-type zeolites, (3) mesoporous silica, and (4) acid-treated mesoporous silica is used.

4. A method of producing an ozone and air two-component gas, the method comprising:
introducing an ozone and oxygen two-component feed gas produced by an ozone producing apparatus into one adsorption column of two or more adsorbent bed-containing adsorption columns present in parallel and adsorbing the ozone, at an adsorption pressure, to the adsorbent and recovering outflowing oxygen-rich gas;
carrying out, during an interval in the adsorption step of re-using the recovered oxygen-rich gas as feed for the ozone producing apparatus, a desorption step by opening, at another adsorption column that has completed the adsorption step, a feed inflow port used in the adsorption step and an oxygen-rich gas outflow port used in the adsorption step and introducing air from an air drying apparatus through the gas outflow port of the adsorption column and thereby desorbing ozone from the adsorbent bed and recovering the ozone gas as an ozone and air two-component gas such that this air serves as a purge gas and is introduced to maintain a regeneration pressure below the adsorption pressure;
then switching the introduction of feed gas from the adsorption column that has completed the adsorption step to the adsorption column that has completed the desorption step; and
repeating the process described above, wherein
as the ozone adsorbent, at least one selected from (1) pentasil-type zeolites, (2) acid-treated pentasil-type zeolites, (3) mesoporous silica, and (4) acid-treated mesoporous silica is used.

5. The method of producing an ozone and air two-component gas according to claims 2 or 4, wherein the air used as the purge gas is dry air, and preferably is dry air that has a dew point of 213 K or below.

6. The method of producing an ozone and air two-component gas according to claims 2 or 4, wherein the flow rate of the air used as the purge gas is determined by the following formula (1)
Gp=k·G₀·Pd/Pa (1)
(where, Gp represents the amount (m³N/h) of dry air used as purge gas; k is in the range from 1 to 2; G₀ represents the amount (m³N/h) of inlet gas; Pd represents the regeneration pressure (kPa); and Pa represents an adsorption pressure (kPa)).

7. The method of producing an ozone and air two-component gas according to any one of claims 1 to 4, wherein the pentasil-type zeolite is silicalite that has an SiO₂/Al₂O₃ molar ratio of at least 20.

8. The method of producing an ozone and air two-component gas according to any one of claims 1 to 4, wherein the pentasil-type zeolite is acid-treated silicalite that has an SiO₂/Al₂O₃ molar ratio of at least 20.

9. The method of producing an ozone and air two-component gas according to any one of claims 1 to 4, wherein the mesoporous silica has an SiO₂/Al₂O₃ molar ratio of at least 20.

10. The method of producing an ozone and air two-component gas according to any one of claims 1 to 4, wherein the mesoporous silica is treated with acid and has an SiO₂/Al₂O₃ molar ratio of at least 20.

11. The method of producing an ozone and air two-component gas according to any one of claims 1 to 4, wherein ozone adsorption is carried out in the range from room temperature to −60° C.

12. The method of producing an ozone and air two-component gas according to any one of claims 1 to 4, wherein the ozone-containing gas is produced by a silent discharge ozone producing apparatus.

13. An ozone gas producing apparatus for carrying out the method according to any one of claims 1 to 4, which introduces an ozone and oxygen two-component gas feed produced by an ozone producing apparatus, into a packed column that contains at least one selected from (1) pentasil-type zeolites, (2) mesoporous silica, (3) acid-treated pentasil-type zeolites, and (4) acid-treated mesoporous silica as an ozone adsorbent bed, adsorbs ozone to the adsorbent by passing the ozone and oxygen two-component gas feed through the adsorbent bed and recovers an oxygen-rich gas, terminates the introduction of the ozone-containing gas when ozone adsorption has been completed, and desorbs ozone by reducing a pressure in the adsorbent bed or introduces air as a purge gas into the adsorbent bed from the rear of the column thereby recovering the ozone as an ozone and air two-component gas.
